(19) United States
(12) Patent Application Publication
(10) Pub. No.: US 2019/0235832 A1
(43) Pub. Date: Aug. 1, 2019

(54) Personal Communicator Systems and Methods

(71) Applicant: Matt Pallakoff, Mountain View, CA (US)

(72) Inventor: Matt Pallakoff, Mountain View, CA (US)

(21) Appl. No.: 15/885,639

(22) Filed: Jan. 31, 2018

(51) Int. Cl. G06F 3/16; G06F 3/0488; G06F 3/0482

(52) U.S. Cl. CPC G06F 3/167; G06F 3/0482; G06F 3/04883

(57) ABSTRACT

Systems and methods for implementing personal-communicator user experiences focus on enabling interactions with a wearable or table-top personal communicator device (“PCOM device”). A PCOM device acts as a speech-optimized peripheral for interacting efficiently with speech-based services and agents. Preferred embodiments of a PCOM system consist of PCOM devices, smartphone- or tablet-based apps (a.k.a. “client” apps), and cloud-based services (i.e. software applications and services that run on servers with which the client apps can communicate via the Internet). A PCOM device is generally wirelessly connected to (e.g. “paired”, typically using Bluetooth® protocols) to the user's smartphone or tablet (a.k.a. “client” device), which runs PCOM-aware software (e.g. one or more apps or services). And the PCOM-aware software communicates wirelessly (typically via a cellular or wi-fi network) with PCOM cloud-based services. In alternative embodiments, PCOM devices could communicate more directly with cloud-based services through cellular connections, Wi-Fi hotspots, or other connectivity technology.

### BACKGROUND

In previous disclosures, the inventor has described classes of wearable personal communicator devices and services, where preferred embodiments of the personal communication devices include features such as a touch sensor on the top surface that can be swiped or flicked repeatedly to navigate through a list of contacts (ideally with the system speaking the name of each contact using text-to-speech, for example) and where the touch sensor can be pressed as the user talks live to a contact (like using an intercom).

Among other things, this disclosure includes descriptions of systems and methods for implementing related personal-communicator user experiences, with a focus on enabling interaction with a wearable or table-top personal communicator device that does not provide any significant visual feedback and therefore must rely primarily on audible or tactile feedback as the user interacts with it.

This document will refer to Personal Communicator devices as “PCOM devices” (or simply “PCOM”) and refer to relate services as “PCOM services” (or simply “services” when it is clear it is referring to PCOM-related services).

### SUMMARY

Among other things, this disclosure discusses:

A preferred core set of features to support on the device (preferably in combination with a smartphone app paired with the device) and an associated preferred gesture set for invoking those features.

Preferred methods for maintaining the order of a user's contact list—keeping it in “most recently used order”—and for allowing a user to then initiate a sequence of swipes through that contact list with a swipe in either horizontal direction (rather than making the user remember which direction corresponds to which direction through the list). This can be useful on a device that does not provide any visual feedback and that can be used in more than one orientation while worn or on a table, since then the user does not need to remember which direction to start a swipe sequence to step through their contacts.

Spoken commands that can be supported in preferred embodiments, including spoken commands that serve as shortcuts to actions a user could also perform with touch gestures (or pressing mechanical buttons) on the personal communicator device.

A multi-tiered client-server system that potentially allows a “speech services” ecosystem or store (or “speech bot” store), and potentially enables third party developers to supply third party speech services and speech bots, which a PCOM user can then access and talk with (or listen to) as easily as they can talk with (or listen to) their human contacts.

Examples of the way the PCOM system can adjust its behavior and forward utterances by a PCOM user in different forms depending on whether or not the receiver is a PCOM user, and whether or not the receiver's PCOM is on and un-muted.

Various additional features that enhance the personal communicator experience, and methods for invoking them and getting confirmation that the methods worked.

It also augments a prior disclosures descriptions of a physical PCOM device design with a brief discussion of the way a clip plate can be attached to the main body of a PCOM device in such a way that the body can rotate up to some limited degree (such as up to 90 degrees) relative to the clip plate, making it easier for a user to aim directional microphone(s) or speaker ports on the edge of the body.

### BRIEF DESCRIPTION OF THE FIGURES

The embodiments of this invention are illustrated by way of example and not limitation in the figures of the accompanying drawings, in which like references indicate similar elements and which:

FIGS. 1A-C diagram how an example list of contacts can be updated as a PCOM user uses gestures to interact with the list.

FIG. 2 is a diagram of the flow implemented for a preferred PCOM system embodiment.

FIG. 3 shows a diagram of a preferred PCOM system embodiment.

FIGS. 4A-B illustrate a PCOM contact list.

FIGS. 5A-C illustrate an example of a preferred PCOM system embodiment that uses a slightly adjusted gesture interaction set to interact “eyes free” with a wider range of non-human contacts (including apps and services).

FIG. 6A shows a left view of the PCOM device.

FIG. 6B shows a top view of the PCOM device.

FIG. 7 illustrates an embodiment of a PCOM system.

FIG. 8 illustrates an embodiment of the PCOM system in more detail

FIG. 9 illustrates another embodiment of the PCOM system used with a wide range of PCOM-enabled devices.

FIGS. 10-11 show variations of the PCOM devices.

### PCOM SYSTEMS AND DEVICES

A PCOM device acts as a speech-optimized peripheral for interacting efficiently with speech-based services and agents.

Preferred embodiments of a PCOM system consist of PCOM devices, smartphone- or tablet-based apps (a.k.a. “client” apps), and cloud-based services (i.e. software applications and services that run on servers with which the client apps can communicate via the Internet). A PCOM device is generally wirelessly connected to (e.g. “paired”, typically using Bluetooth® protocols) to the user's smartphone or tablet (a.k.a. “client” device), which runs PCOM-aware software (e.g. one or more apps or services). And the PCOM-aware software communicates wirelessly (typically via a cellular or wi-fi network) with PCOM cloud-based services. In alternative embodiments, PCOM devices could communicate more directly with cloud-based services through cellular connections, Wi-Fi hotspots, or other connectivity technology.

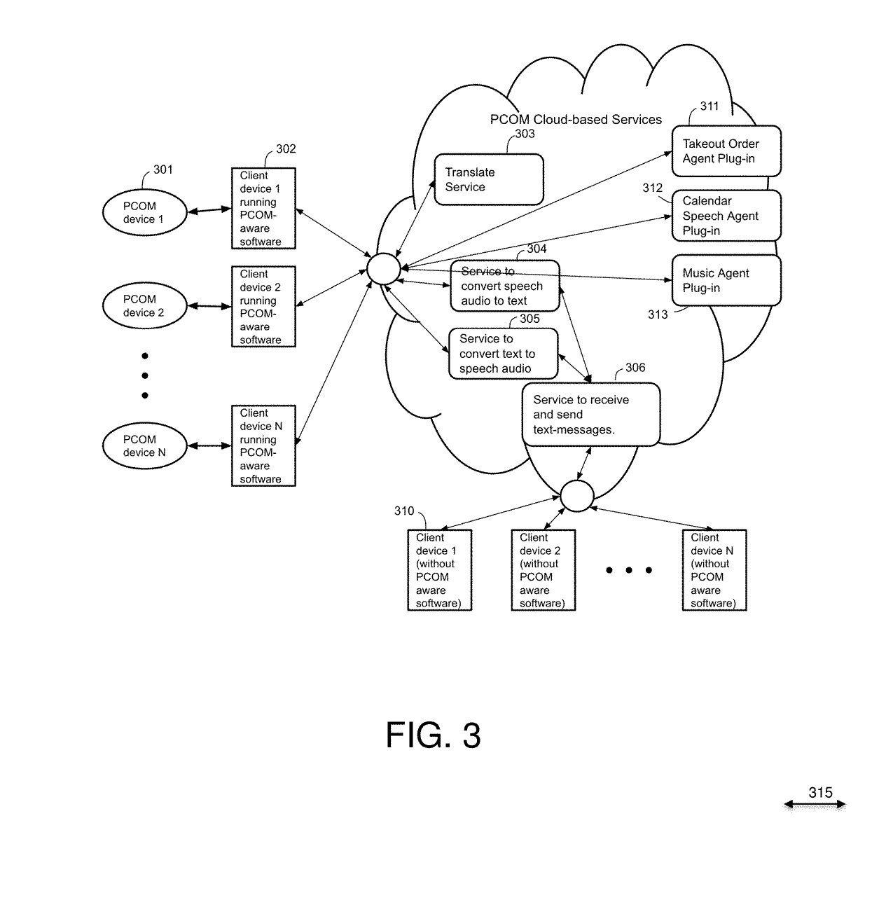

FIG. 3 shows a diagram of one such preferred PCOM system embodiment. Some elements will be discussed in greater detail elsewhere in this document, but here is a quick example of how the PCOM system illustrated in FIG. 3 can function: A user using a PCOM device 301 paired with a smartphone or other client device 302 who has enabled access to a “Translate” speech service 303 could swipe through his list of contacts (which can include the names of people, virtual agents, and speech services) until hearing “Translate” and then tap to activate the Translate service (or the user could tap+press-and-hold and say “Translate” to activate the Translate service)—and then the user could press-and-hold to speak utterances to the Translate service and hear the Translate service speak back a translated version of that utterance. A PCOM user can also speak to a contact who is using a smartphone 310 but who is not using a PCOM device or PCOM-aware app (or who has his PCOM muted, depending on the receiver's preferences and system configurations), and the PCOM system can use a speech recognition software service 304 to convert that speech audio into text, and use a text-messaging-forwarding service 306 to forward that text to the smartphone 310 or messaging app of the user who is not using PCOM. Similarly the contact using that smartphone 310 could reply by text, and the PCOM system can use a text-message receiving service 306 and text-to-speech conversion software service 305 to convert the text to speech and forward it back to the smartphone 302 of the PCOM user who initiated the exchange, so the reply can be played as audio on that person's PCOM device 301.

A preferred PCOM system embodiment would include some services by default (such as including one that can convert speech audio to text 304 and one that can convert text to speech audio 305) and would also allow plugging in additional speech services and agents, including ones from third parties. For example, a third party software developer could develop a “Takeout Order” virtual agent that allows a user to engage in a dialog to order takeout food from restaurants, and make it available to PCOM users as a PCOM system plug-in 311. Another third party developer could provide an agent plug-in 312 that lets a PCOM user ask about upcoming meetings in the user's calendar. And another developer could provide an agent or service plug-in 313 that lets a user navigate through the user's music playlists or online radio stations. In preferred PCOM system embodiments, a basic form of a speech service like the Translate service 303 could be provided standard with a preferred PCOM system embodiment, and third parties would be able to provide potentially better Translate service plug-ins, covering more languages or improving on the translation quality, for example.

Note that in preferred embodiments, a PCOM agent plug-in or service plug-in does not necessarily need to embody the full virtual agent code base: It could just be a module that uses PCOM system APIs to connect the PCOM system with third party developer's existing agent (which could run on other remote servers). The PCOM devices and system can then let a user activate access to a given third party agent or service (e.g. by swiping through the user's contact list and tapping or press-and-holding) and then when the user speaks (or writes) when that agent or service activated the PCOM system will forward speech audio or text to that third party agent or service; and similarly, when the third party or agent responds (with text or audio), the PCOM service would relay the response back to the PCOM user. The two way arrow 315 in FIG. 3 is represents communication between an example Calendar agent PCOM plug-in module and an outside calendar service that can run on remote servers—where the PCOM plug-in module uses PCOM APIs to facilitate communication between the PCOM system and the outside calendar agent service. (The outside calendar agent service is not explicitly represented by any box in FIG. 3.)

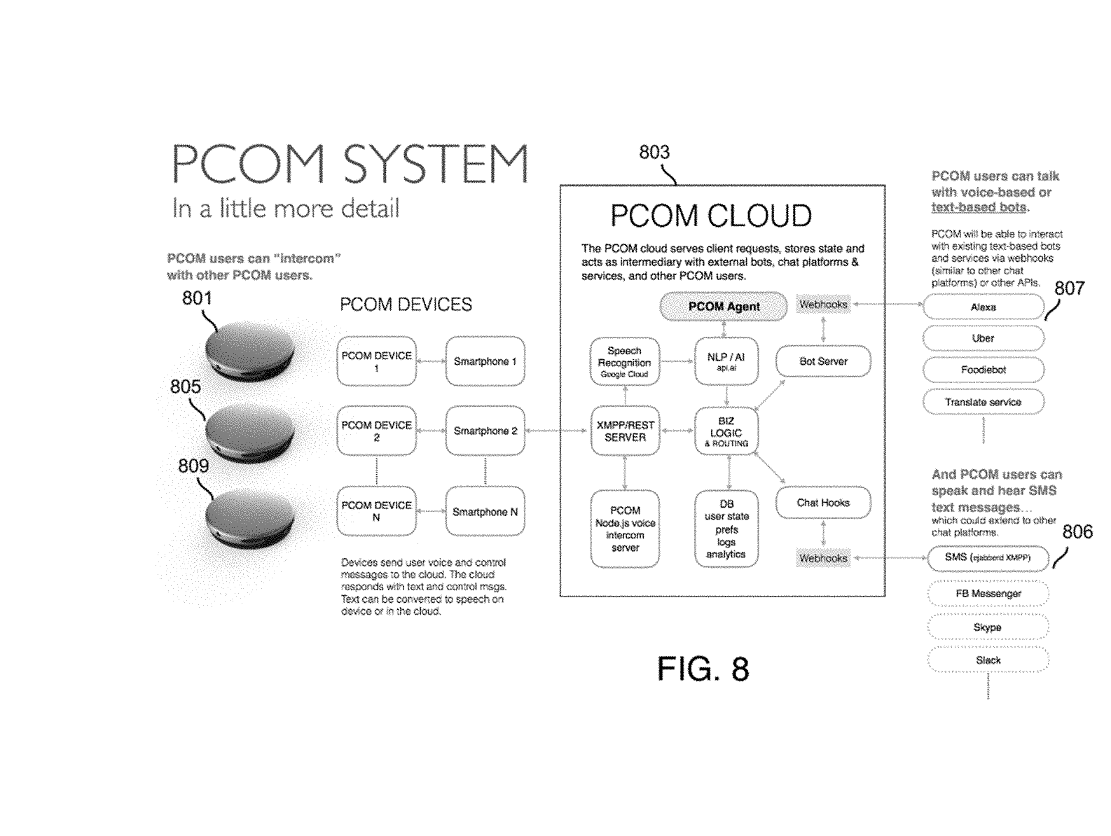

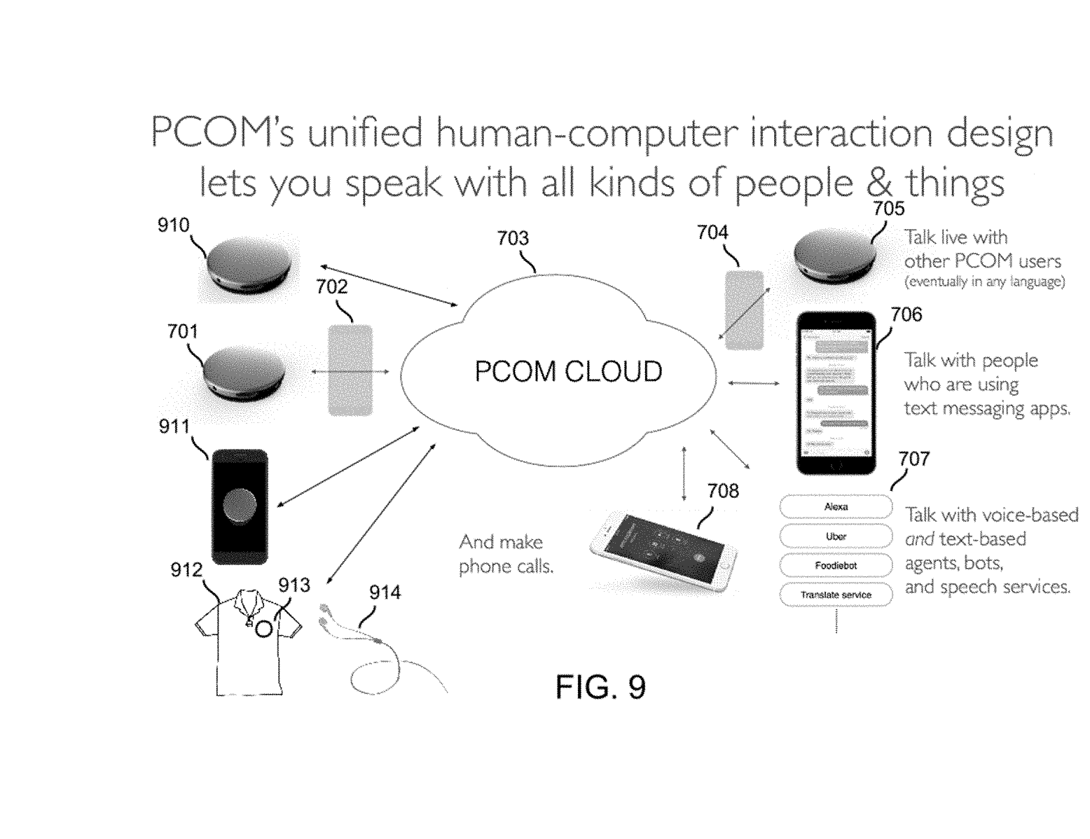

FIGS. 8 and 9. show alternative illustrations of PCOM system embodiments. These are described later in this disclosure.

(In this disclosure, the terms “PCOM plug-in”, “PCOM system plug-in”, “PCOM service plug-in”, “PCOM agent plug-in”, and “Plug-ins” all represent these types of plug-in modules that allow the PCOM system to communicate with additional services or agents that aren't necessarily part of the PCOM system.)

In preferred embodiments, third party developers could create PCOM compatible agents, services, and apps—or make their existing agents, services, or apps compatible with PCOM by creating PCOM plug-ins that connect those apps to PCOM systems. And in preferred embodiments, a PCOM System would allow users to acquired, purchase, or subscribe to a wide range of such PCOM-compatible agents, services, and apps. In preferred embodiments, this could be embodied in a PCOM “agent store” (or “speech bot store” or “speech services” store).

In addition, preferred embodiments would support PCOM-compatible speech-based advertising agents or services and information-providing agents: For example, if a user is using a PCOM device while waking around town or driving somewhere, a virtual agent or speech service could keep the user informed of events, offers, or interesting information related to nearby locations. (“The coffee shop on this street gets 5 star reviews.”, “Bruce Springsteen is playing here next month.”, etc.) This feature could be part of a location aware, speech-based advertising network embodied as a speech service or virtual agent that could serve speech-based ads to individual PCOM that are, in preferred embodiments, chosen or customized for each user based some combination of context and attributes such as the user's current location, mode of transportation (walking vs. driving?), time of day, user preferences, user profile information, and so on. In some of these embodiments, advertisers to could pay when an advertising agent advertises their product or service, or pay when the user responds in some way (such as doing some gesture or speech command after hearing an add that indicates they'd like to be reminded about a given offer, or that they'd like to take some action related to it).

In preferred embodiments, a plug-in agent or service could allow either text input/output, or speech input/output, or both text and speech input/output—with plug-in configuration files indicating what form of input and output is supported by the plug-in: And if a plug-in agent indicates that it only supports text input and output (not speech input and output), then a preferred PCOM system embodiment can chain input and output from that plug-in agent with standard PCOM services for doing text-to-speech 305 and speech-to-text 304, as discussed next, enabling PCOM users to still speak to that plug-in agent even though it does not directly support speech audio input or output.

As noted, PCOM system embodiments can also allow chaining of PCOM services—including potentially chaining services that are a standard part of the PCOM cloud services and third-party supplied speech services and agents that plug into the PCOM cloud services. For example, a PCOM system embodiment could allow chaining a PCOM-standard speech-audio-to-text conversion service 304, a third party Translate service 303 (that in this example should be capable of translating text), and a PCOM-standard text-message forwarding service 306—to let a PCOM user speak an utterance into a PCOM device 301 in a first language, have a PCOM app on a smartphone 302 send that audio to the Internet-based PCOM cloud services, use the audio-to-text service 304 to convert the utterance audio to text, then use the Translate service 303 to translate the resulting text to a second language, then use the text-messaging forwarding service 306 to forward that text to the phone 310 of a non-PCOM user.

Preferred embodiments of the PCOM app for smartphones or tablets can also emulate a PCOM device, by allowing a user to speak into the smartphone as if it is a PCOM device, and preferably by also allowing the user to invoke PCOM functions via touch gestures on a screen in the PCOM app that are similar to the touch gestures a user would perform on a PCOM device to invoke similar functions, such as pushing-to-talk. While this might not be as comfortable or convenient as pushing-to-talk and speaking into a well designed wearable PCOM device, it can be useful for people who want to use the PCOM service but do not yet have a a PCOM device/peripheral. For example, someone who wants to try out PCOM services before ordering a PCOM device could first download a PCOM smartphone app and try using an emulated PCOM device implemented as part of the PCOM smartphone app.

Preferred embodiments of the PCOM app can also allow users to type messages (e.g. using a virtual keyboard and a text-entry box) instead of speaking them, which can be useful in situations where the sender does not want to speak. In these cases, when the receiver is using a PCOM device or PCOM app that is on and un-muted, the PCOM service or the receiver's PCOM app can transform the typed text into speech audio (using text-to-speech software) and the receiver's PCOM app can play that audio through the user's PCOM device or PCOM app.

As discussed in the inventor's prior disclosures, a preferred embodiment of a PCOM device includes components such as the following:

Touch sensor on top surface.

One or two microphones.

At least one speaker.

Power button.

A means to charge, such as a micro USB port.

A multi-color LED.

A vibration component—for haptic feedback.

A flat clip—to clip to clothes.

And optionally a headset port (such as the standard 3.5 mm telephone headset jack port like those included in most smartphone devices).

In preferred embodiments, the clip is flat so it can serve as a flat base when the device sits on the table, and the clip plate extends in back (the “tail”), to help slide onto clothes and to provide a good visual cue as to which side is the back vs. the front.

In some PCOM device embodiments, the clip plate, body, or hinge post mechanism includes a means to allow the clip plate to rotate relative to the main device body. It can either allow continuous rotation, or it can allow rotating up to some maximum amount (such as 90 degrees). Allowing this rotation can make it easier for a user to aim a microphone or speaker on the edge of the PCOM device body toward the user's head, after clipping the device to a shirt, for example. There are many ways to implement such rotating clip mechanism, including having a disc on the bottom of the PCOM device's main body attach in a way that allows it to rate and then attach the clip plate to that disc using a fixed post.

Alternative embodiments can use one or more mechanical buttons to let a user navigate through the contact list (e.g. tap a button instead of swiping a touch sensor to go to the next name in the contact list, and perhaps tap a different button instead of swiping the touch sensor in the other direction to go to the prior name in the contact list) and to perform various functions (e.g. press a button for push-to-talk, or to tap a button to place a call, or use mechanical buttons to adjust volume). And alternative embodiments could use mechanical rotary switches, dials, or jog-dials for some functions, like adjusting volume or sweeping through a list of contacts. But swiping the surface of a relatively small disc-shaped device (flat, slightly concave, or slightly convex) feels natural and intuitive when navigating through a list, even without visual feedback, provided there is appropriate audible feedback in response to each swipe.

Note that preferred embodiments of PCOM can have relatively low power processors and rely on the ability to communicate with a nearby smartphone, where the nearby smartphone or the cloud-based services with which it communicates would handle more complex tasks. But alternative embodiments of PCOM devices can have cellular radios, and the other necessary components (like SIM cards) to communicate directly to the cloud-based service through cellular networks—with a user being able to configure features using a web-based interface. Still other embodiments of PCOM devices could use wi-fi radios and communicate through wi-fi hotspots directly with the cloud-based services.

PCOM Touch Gestures

In preferred embodiments of PCOM devices and systems designed according to the present invention, a user can perform touch-based gestures on a two dimensional (“2d”) touch sensor on the PCOM's surface to invoke functions, including two or more (and preferably all) of the following gestures and functions:

Press-and-hold to talk with your “Current PCOM Contact”

When two PCOM users communicate with preferred embodiments of PCOM devices and PCOM systems, it works like an Intercom: When a PCOM user presses-and-holds on the touch sensor of his PCOM device, then speaks into one of the PCOM device's microphones (i.e. “intercoms” with the other user), the audio is transmitted through the first user's smartphone to the cloud based service, which relays it to the other PCOM user's smartphone and paired PCOM device.

In preferred embodiments, if a first user “intercoms” (i.e. speaks a message to) a second non PCOM user, the PCOM system can convert the first users spoken message into text using speech recognition software and then forward that text to the second user as a text message (in some embodiments as a standard phone TXT message that the second user can see on their smartphone, for example).

Similarly, in preferred embodiments, if first user sends a text message to a second user who is using a PCOM device, the PCOM system converts the text message to speech audio (e.g. using text-to-speech/speech synthesis software) and plays the audio it to the second user.

In this way, a PCOM users can use speech to communicate in near real time with someone else (and potentially with virtual agents and speech services) using text-messaging.

In specific implementations, fairly complicated rules and user preferences can be applied to determine exactly when a spoken utterance from one user or agent should be converted to text and sent to a text message to another person or agent, and vice versa. For example, the PCOM system could allow one user to configure their PCOM setup so that, when the user's PCOM is on but muted, any incoming audio utterances will be converted to text and forwarded to the user's phone as a standard TXT message; and it could allow another user to configure their PCOM to vibrate under the same condition (i.e. when the second user's PCOM is on but muted) and let the user hear that incoming audio when they tap their PCOM's touch sensor within a certain amount of time after that vibration. Other configurations are possible, of course.

If a PCOM contact “intercoms” you, they become your new “Current PCOM Contact”, which means you can just push-to-talk to respond. (Embodiments may configure exceptions to always making an incoming “intercom” sender the new Current PCOM Contact, but it is a useful feature in general.)

Swipe substantially horizontally to hear the name of your most recently used contact (i.e your “Current PCOM Contact”); swipe again in the same direction to hear the name of the contact used before that; and so on. The system can use speech synthesis (or recorded audio) to speak each name, so the user can hear it. If you swipe to a new name in this way, then when you press to talk (or simply tap), that name becomes your new “current PCOM contact”. This minimizes the effort to talk with frequently used contacts. Section 4.3 has details. As discussed below, preferred PCOM embodiments allow a user to start this type of swipe sequence with a swipe in either direction, so a PCOM user does not need to remember which way to swipe to start hearing names in the user's list of contacts. As discussed in more detail below, in preferred embodiments, a PCOM user can also include virtual agents and speech services among their contacts.

Slide substantially vertically up or down to adjust volume. Or flick down or up to mute or unmute the PCOM device when it's being used to intercom. If a call is in progress, the flick-down can end the call.

As seen on current smartphone touch interfaces, a flick is generally a quick short swipe where the finger is still moving when it lifts. A “slide” can be slower, and the finger can stop before it lifts.

Double-tap to hear the name of the current PCOM contact again (in case you forget).

Tap to answer an incoming phone call, when there is an incoming call.

Trace an approximate circle (e.g. it can look roughly like an “O” or a “C” or a spiral, traced in either direction) to initiate a phone call to the Current PCOM Contact. If a call is already in progress, and the user swipes to a different contact and does this circular gesture, it could call another person—and either merge the two calls into a group conference or act as a second call line, depending on configuration.

Tap+Press-and-Hold to tell the PCOM system to listen for a spoken command (as discussed below). This is like a double-tap, but the finger stays down after the second touch down.

Alternative embodiments can use alternative gestures or physical mechanisms for these functions. For example, a PCOM embodiment could allow a user to initiate a spoken command by double-tapping the PCOM device touch sensor. In such cases, the system would need to rely on the detecting some silence at the end of the utterance to determine when the user is done talking (which can be error prone in noisy environments) or rely on a subsequent gesture (such as another tap). While these are reasonable alternatives, we have found it more reliable to require the user to continue to press the touch sensor while speaking the utterance—with the finger lift indicating the end of the utterance—when a PCOM device is designed with a microphone that can be used from more than a few inches from the user's mouth (as is the case for PCOM devices that can be worn on a shirt pocket or sat on a desk in front of the user).

Alternative embodiments could use a touch sensor to detect the basic Press and hold gesture, and then use a mechanical button that requires harder press (instead of a Tap+Press-and-Hold gesture on a touch sensor) to tell the PCOM System to listen for spoken commands.

Still other embodiments could use a force-sensitive touch sensor—or a force-sensitive mechanical button that can detect more than one level of force—and interpret a light press as the intent to speak to the Current Contact while interpreting a significantly stronger press as an intent to speak spoken commands to the PCOM System.

Those skilled in the art can define other methods for distinguishing speech meant for a contact from speech meant for the PCOM System (e.g. the part of the PCOM System called the “PCOM Agent” in other parts of this disclosure): The point is that it is useful to allow the user to use one means to tell the PCOM System to send a message to a Current Contact, and all the user to use a second means (distinguishable from the first means) to tell the PCOM System to listen to and respond to a spoken command (which could include automatically routing a message to a named contact as described below).

Alternative embodiments could also leave the microphone “open” all the time—and listen for a keyword spoken by the user to initiate spoken commands, as allowed both by recent speech recognition systems—like Amazon's Echo (which listens for “Alexa”), Apple's “Ski”, and Google's “OK Google”—and by early speech recognition systems such as Apple's PlainTalk in the early 1990s. (The inventor designed and developed much of that PlainTalk speech recognition system.) But again, as with some of those early systems, we have found that the system is more reliable when it uses a push-to-talk approach instead of an open-mic—especially in noisier environments. So preferred embodiments of the present invention that support an open-microphone option would allow users both options—at times configuring their PCOM device and system to work with an open mic and optionally listen for a keyword (e.g. to support commands or questions like “PCOM, what time is it?”), and at other times configuring them to require the user to continue pressing while speaking a spoken command (e.g. require a tap+press-and-hold gesture, and continue holding while speaking the question or command, without needing to speak the keyword).

PCOM Spoken Commands

In preferred embodiments of PCOM devices and systems designed according to the present invention, a user can also speak commands to invoke certain functions, including one or more (and preferably all) of the following spoken commands and functions:

Initiate a phone call by speaking a command like “Call Joe Smith” or “Phone call to Mary Roberts”.

Make a given contact or speech service the “Current PCOM Contact” by speaking a command like “Contact Mary Roberts”. In preferred embodiments, this would be a shortcut equivalent to swiping through the contact list until hearing the name “Mary Roberts” and then pushing-to-talk (to talk with Mary) or just tapping.

Make a given speech service the Current PCOM Contact by speaking the name of the speech service—such as speaking “Translate” or “Order Takeout” (where the user has previously enabled a speech service with the name “Translate” and a speech service with the name “Order Takeout”).

Route spoken messages to a named person, agent, or service, by addressing the spoken message to that name. For example speaking “Kim, I'll be home soon” to the part of the system that routes such spoken messages gets routed to the contact associated with the name Kim; “Uber, I need a ride” can get routed to an agent named Uber; and natural language variations such as “Hey Danny, are you ready for the meeting?”, “Yo, Danny, are you ready for the meeting?”, or “Tell Danny: Are you ready for the meeting?” can get automatically routed to the contact named Danny.

In preferred embodiments, a user can also designate a preferred default agent that could receive any other spoken utterances. For example, if the system supports commands that begin with “Call”, “Phone”, and “Contact” (optionally after a phrase like “Please” or “Could yo please”), as well as utterances that start with the name of one of the user's contacts or enabled agents, then if the user invokes a speech-command (perhaps by preforming a gesture like tap+press-and-hold and speaking) and speaks a phrase like “What time is it?”—where that phrase does not match any of the supported commands, contacts, or agents—then by default the PCOM system can let the user's designated default agent try to respond to that utterance. For example, if the user's designated default agent is Alexa, then the utterance “What time is it?” would be passed to Alexa, and the Alexa agent would likely respond by stating the time.

As noted earlier, in preferred embodiments, the PCOM device or PCOM System have mechanisms or means that let the user help the system distinguish between speech that is to be sent to the users Current Contact (as done when pressing the button of a standard Intercom) and speech that is to be processed by and interpreted by a part of the PCOM System that handles spoken commands like those in the last several paragraphs. (This part of the PCOM system can be referred to as the “PCOM Agent”—as designated by the “PCOM Agent” box in FIG. 8.)

Also as noted earlier, this mechanism for distinguishing speech to a contact vs speech to the PCOM Agent can be done in several ways. In one preferred embodiment, a press on the PCOM device's touch sensor (a.k.a. a press or a push-to-talk or PTT) can behave like an intercom button for talking to a contact, while a tap followed by a press on that touch sensor (a.ka. tap+press or tap+push-to-talk or tap+PTT) can be used to indicate that speech occurring during that press should be directed to the part of the system that processes spoken commands (a.k.a. the PCOM Agent). For example, if a user's current contact is a contact named “Danny”, then a user might press the PCOM button and say “I'll be there in 10 minutes”, and that message will be sent to the contact named “Danny”; then the user might tap+press and say a spoken command such as “Kim, did you email the letter?”— and the PCOM Agent could automatically route to the person (or agent, bot or service) named “Kim”, even though the user's Current Contact had been Danny. (The PCOM System can then also change the user's Current Contact to Kim, so the user can just press-and-talk to say something else to Kim.)

While describing this interaction approach in text can take a lot of words, the resulting user experience is very natural: A user does the tap+press-and-hold gesture and says “Call Joe Smith” to call Joe Smith. Or a user does a tap+press-and-hold gesture and says the name of a specific agent or person to start interacting with that agent or person. Or a user makes a general speech command or request like “What time is it?”, and the user's default agent responds.

As noted above, in preferred embodiments, a PCOM user can include virtual agents and speech services among their contacts (along with human contacts). For example, a PCOM user might have Amazon's “Alexa” as one of their contacts. And a PCOM user might include a “Translate” speech service as one of their contacts (where the “Translate” service could be a speech-based translation service provided by some other company, where that Translate service takes audio input representing a phrase spoken by the user and speaks back a synthesized speech audio representation of that phrase translated to another language). In this case, as the PCOM user swipes through the user's list of PCOM contact names, when they get to the “Alexa” contact name they will hear “Alexa” spoken by the PCOM system—at which point they could press-to-talk to speak a command or question to Alexa, and then hear Alexa's reply—just like “intercoming” with a human contact. Similarly, the user could swipe until they hear “Translate”, then press-to-talk to speak a phrase, then hear the Translate speech service speak back the translated phrase. As with human contacts, talking with the agent or speech service—or simply tapping after swiping and hearing its name—can make that agent or speech service the new Current PCOM Contact, so the user can instantly say something else to that agent or speech service simply by pressing and talking again.

We will also refer to that act of making an agent or speech service the Current PCOM Contact as “activating” the speech service or agent. So a user can “activate” the Translate service by swiping through the user's PCOM contact list until hearing “Translate” and then tapping once or pressing-and-holding (and optionally speaking something)—assuming the user had previously enabled “Translate” as one of his available speech services.

Note that with this approach, the PCOM user can easily talk with a variety of speech services or agents (or people!) using the same simple interface. And the PCOM user does not need to re-state the name of the agent each time the user wants to say another thing to a given agent—which is convenient when making a series of commands or requests to a given agent that isn't the user's primary agent.

For example, with preferred PCOM devices and service embodiments, one could swipe to the “Translate” speech service, press-to-talk and say a phrase to be translated—then press-to-talk and say another phrase to hear another phrase translated (assuming the user chose the target language once ahead of time). So if you were traveling in Sweden, you could configure your Translate agent to translate from English to Sweden, and when you meet someone who only speaks Swedish you could swipe to the Translate speech agent on your PCOM, and press-and-speak a series of phrases—e.g. “Where is this hotel?”, “How far is that”, “Thank you!”, “Good night.”—and both you and a person in front of you could hear the translation after each utterance.

By contrast, if one created a similar “Translate” skill for Amazon's Alexa agent, and wanted to use it several times in a row on Amazon's Echo, it appears that one would to have to say “Alexa Translate. . .” before each phrase to be translated—e.g. “Alexa, translate where is the hotel?”, “Alexa, translate how far is that”, “Alexa, translate thank you”, “Alexa, translate good night”. Even when using a push-to-talk remote with Alexa—which eliminates the need to say Alexa before each utterance—it appears one would still need to say “Translate” (the skill name) before each phrase—e.g. “Translate where is the hotel”, “Translate how far is that”, “Translate thank you”, “Translate good night”. That is a bit more tedious than the PCOM approach (which allows the user to simply press and say the phrase to be translated), and may be more prone to misidentifying the phrase and the inflection of the phrase to be translated (so questions may be more likely to sounds like statements).

Command-and-control speech recognition systems generally use language models to constrain what sorts of commands the system will listen for at any given time. One method for describing language models is described on the web site at: https://www.w3org/TR/jsgf/. Using that sort of approach, a language model describing the sort of commands outlined above (and allowing some flexibility in how the user speaks some of the phrases) might look like the following:

```
  <my-pcom-agents> = ( Alexa | Uber | Order Takeout | Siri |
  Open Table );
  <recent-pcom-humans> = ( Joe [Smith] | Mary [Roberts] |
Nathan [Williams] | Peter [Askins]);
  <current-contact-reference> = ( this contact | him | her | them | now );
  <intercom-phrase> = contact | intercom with | talk (to | with) | talk
(to | with) | connect (to | with);
  <phone-call-phrase> = call | phone | make a phone call to;
  public <PCOM-voice-commands> = [<Please>] (<intercom-phrase> |
  <phone-call-phrase>)
  (<my-pcom-agents> | <recent-pcom-contacts> |
    <current-contact-reference>);
```

With this language model, a user could speak phrase such as:
“Call Mary Roberts” (to place a phone call to Mary)
“Please make a phone call to Nathan” (to place a phone call to Nathan)
“Talk with Peter” (to make Peter the Current PCOM contact, so the user can then simply push-to-talk to “intercom” with Peter).
“Uber” or “Talk to Uber” (to make the Uber agent the “Current PCOM Contact”, so the user can than simply push-to-talk to peak to the Uber agent, just like “intercoming” with a human contact).
“Order Takeout” (to make the “Order Takeout” agent the “Current PCOM Contact”, so the user can than simply push-to-talk to peak to that agent, just like “intercoming” with a human contact).

This can be extended to support larger sets of spoken commands. Of course, the system must also include software that interprets and responds to each class of spoken commands, as is standard with speech recognition based agents like Alexa, Siri, OK Google, and (20 years earlier) PlainTalk.

### Some of These Functions are now Described in More Detail.

In preferred embodiments, a PCOM user can talk live (“intercom”) with other PCOM users and with virtual agents—individually or in groups. The PCOM users may communicate through PCOM devices or through PCOM applications on smartphones. The PCOM applications can be thought of as PCOM device emulators.

In preferred embodiments, a PCOM user can also speak and hear text-based messages with people who don't have (or are not currently using) a PCOM device or app. For example, in preferred embodiments of the PCOM system, when a PCOM user attempts to intercom with another person (who could be uniquely identified through the other person's phone number), where that other person is not a PCOM users (e.g. does not have a PCOM account) or currently does not have their PCOM app open or PCOM device on, then preferred embodiments of the PCOM system can use speech recognition software to convert the sender's spoken utterance into text and forward the resulting text as a TXT message to the receiver's phone (or forward as a text message to a text-based messaging app used by the receiver).

Similarly, if a PCOM user is in a situation where they do not want to speak (such as in a library), preferred embodiments of the PCOM app would also let the user type a text message to an intended receiver, and if the receiver had a PCOM device turned on and un-muted (e.g. paired to receiver's smartphone and communicating through a running PCOM app on the receiver's smartphone), then the PCOM service and the receiver's PCOM app would work together to convert the sender's text into speech audio (e.g. using text-to-speech/speech synthesis software in the app or in the cloud-based PCOM service) and to play that audio through the receiver's PCOM device.

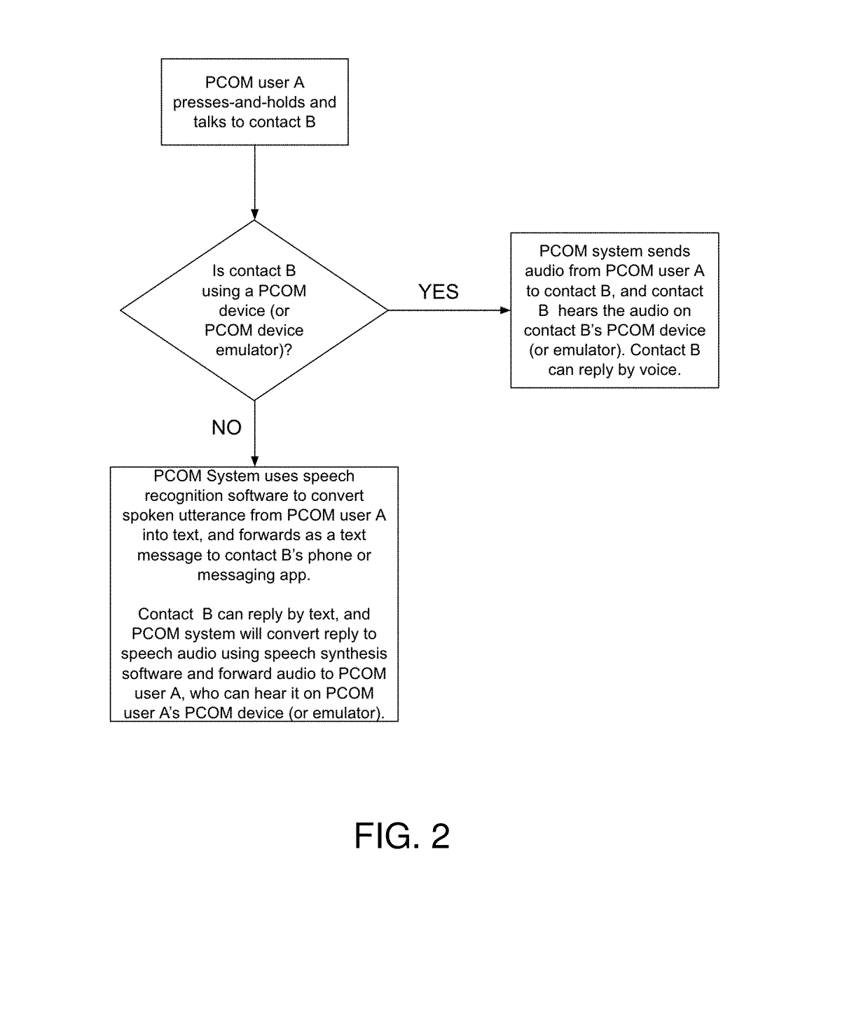

FIG. 2 is a simple diagram of the flow implemented for a preferred PCOM system embodiment for a couple cases described above. A PCOM user A can use the PCOM device (or an emulated PCOM device in an app) to speak to a contact B. If contact B is using a PCOM, then contact B can hear the utterance from PCOM user A and reply using speech: The PCOM system will send the audio reply and PCOM user A will hear it. But if contact B is not using a PCOM device when PCOM user A tries speaking an utterance to contact B, then the PCOM system can use speech recognition software to convert the utterance to text and forward the text to contact B's phone or messaging app as a text message; and if contact B replies by text, then the PCOM system can use speech synthesis software (a.k.a. text-to-speech software) to convert the text to audio and send that audio to PCOM user A who can hear it on PCOM user A's PCOM device (or emulated PCOM). This is particularly useful if contact B text-messages user A while user A is driving and can't safely look at a phone.

There can be some different combinations of conditions—senders' or receivers' having or not having a PCOM account, having or not having the PCOM app open/running, having or not having a PCOM device running, with the PCOM device muted or not muted, and so on.

In preferred embodiments, the PCOM apps and/or web-based PCOM service interfaces can also let users configure different responses for different situations. For example, a given user might want all PCOM intercom voice messages that are sent to them to be converted to text and forwarded as regular TXT messages to their phone during certain hours of the day, except for PCOM intercom messages from the user's spouse.

In preferred embodiments, if a PCOM contact “intercoms” you, they become your new “Current PCOM Contact”, so you can just push-to-talk to respond. In preferred embodiments, your PCOM app or service can be configured to state the new “Current PCOM Contact's” name when someone “intercoms” you and becomes your new “Current PCOM Contact” in this way—so you know that your current contact has changed. (Some users may choose not to have the new name spoken for some familiar contacts, if they are confident they will recognize the contact's voice. (For example, you may not need to have the PCOM device state your spouse's name each time she or he “intercoms” you when he or she is not already your Current PCOM Contact.)

As noted, in preferred embodiments, a user can swipe substantially horizontally (and this first swipe can occur in either direction) to hear the name of your most recently used contact; swipe again in the same direction to hear the name of the contact used before that; and so on. When the user swipes to a name in this way and then presses to talk (or simply taps), then that name becomes the user's new “Current PCOM Contact”—so the user can talk to that contact again by simply pressing-and-holding again and talking (i.e. press-to-talk). For determining “recently used”, examples of “used” should include using PCOM to intercom with that PCOM contact, or using PCOM to call that contact—and may include being contacted by another contact while you are using PCOM (though embodiments can include restrictions).

The phrase “substantially horizontally” refers to swiping across the width of the PCOM device—substantially perpendicular to a substantially vertical swipe, which would occur from the top of the device toward the bottom of the device or from the bottom toward the top (where the physical design of preferred embodiments of the PCOM devices make it clear where the top and bottom are). This is discussed more below. As is common with swipe gesture detection on smartphone touch-screens, swipe gesture detection on PCOM devices should tolerate quite a bit of variance: For example, in most PCOM embodiments—including the preferred embodiments discussed in this document that do not need to support diagonal swipe detection—a mostly straight swipe longer than some minimal distance (which could be small, like 3 mm) whose direction is within about 45 degrees of horizontal could be considered a substantially horizontal swipe, and a swipe longer than that minimum distance whose direction is within about 45 degrees of vertical can be considered a substantially vertical swipe.

(Of course, in PCOM implementations that also use diagonal swiping to invoke some function, distinct from functions invoked through horizontal and vertical swipes, horizontal and vertical swipes would need to be constrained to tighter range—such as within 30 degrees of horizontal for horizontal swipes and within 30 degrees of vertical for vertical swipes. But on devices that are worn in positions where they are not easy to see and where they are often not perfectly lined up to a clear reference point, it is a good idea to avoid requiring that fine of control over swipe angle direction, to avoid mistaken gesture interpretation.)

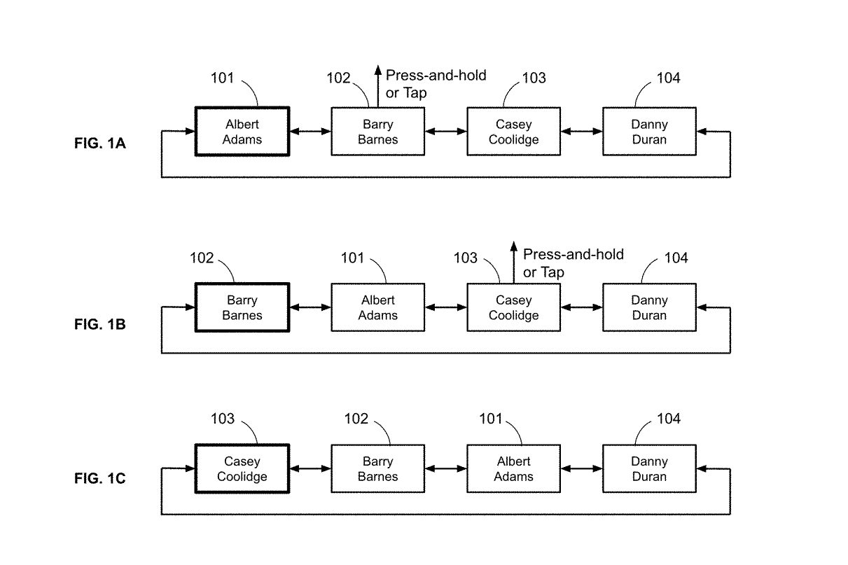

FIGS. 1A, 1B, and 1C diagram how an example list of contacts can be updated as a PCOM user uses gestures to interact with the list. In this example, the “PCOM Contact List” starts out with four contacts named “Albert Adams” 101, “Barry Barnes” 102, “Casey Coolidge” 103, and “Danny Duran” 104. In this example, the list starts with the names listed in alphabetical order, as shown in FIG. 1A. In a preferred embodiment, if a user then swipes substantially horizontally (e.g. within about 45 degrees of horizontal, though different implementations can use different degrees) in either direction, the user will first hear the name of the first name in the list (which here we'll call the “PCOM Current Contact” and designated with a bolder box around the name)—“Albert Adams” in this example. Then if the user swipes in the same direction again within a relatively short amount of time (for example, within about 10 or 15 seconds), the user will hear the name of the second contact in the list—“Barry Barnes” in this example. And then if the user swipes in the same direction again within a relatively short amount of time, the user will hear the name of the next contact in the list—“Casey Coolidge” in this example; and so on. If the user swipes substantially horizontally but in the other direction compared to the first swipe in the sequence, the user will hear the name of the prior contact in the list: For example, if the user swiped right to hear the second name in the list (“Barry Barnes” in the example illustrated in FIG. 1A), and then swipes left within a relatively short amount of time, they will hear the first name in the list again (“Albert Adams” in the example in FIG. 1A). (Note, when the system speaks the name of a contact, it can be configured to either speak the whole name—e.g. “Barry Barnes”—or speak just the first name—e.g. “Barry”—or speak some other representative name—e.g. “Mr. Barnes”—depending on user preference and/or whether the name might be confused with other similar names in the list unless the full name is spoken.)

After swiping substantially horizontal and hearing the name of a contact, if the user then does a designated gesture for choosing or interacting with that contact (such as pressing-and-holding or simply tapping), then that contact becomes the new “PCOM Current Contact” and is moved to the front of the list. For example, while swiping through the example PCOM Contact List illustrated in FIG. 1A, if the user hears the name “Barry Barnes” (represented by item 102) and then presses-and-holds (or simply taps), then the contact “Barry Barnes” becomes the new PCOM Current Contact and gets moved to the front of the list, as illustrated in FIG. 1B—and the prior PCOM Current Contact (“Albert Adams” 101 in this example) becomes the second contact in the list illustrated in FIG. 1B. Similarly, if the user swipes substantially horizontally three times in the same direction to hear the name of the third contact in the list (“Casey Coolidge” 103 in the examples illustrated in FIG. 1A and FIG. 1B), then that contact becomes the new PCOM Current Contact and gets moved to the front of the list, as illustrated in FIG. 1C—and the 1st and 2nd names that had been in front of “Casey Coolidge” (i.e. “Barry Barnes” 102 and “Albert Adams” 101 in the example illustrated in FIG. 1B) are moved down the list accordingly, becoming the 2nd and 3rd names in the updated list in the example illustrated in FIG. 1C.

The approach just described has the effect of maintaining your PCOM Contact list in most-recently-used order—i.e. your current PCOM contact (the one you will be talking to if you press-to-talk) is at the front of the list; the next-most-recently used contact is next in the list; and so on.

This has at least two important advantages compared to simply maintaining a static contact list and letting the user step through the contact list in one direction by swiping the PCOM's touch sensor (or a PCOM app's screen) in one direction and letting the user step through the contact list in the other direction by swiping in the other direction (though that is a reasonable first-cut design and implementation for someone prototyping an initial PCOM system).

A first significant advantage of maintaining your PCOM Contact List in most-recently-used order is that it helps minimize the number of swipes (and hence the effort) required to switch to your frequently used contacts—since your frequently used contacts will naturally tend to wind up near the front of the list. And the one you are currently talking with (or have most recently been talking to) is at the front of the list, so you can just push-to-talk to continue talking with them.

A second major advantage to this approach is that it allows the user to initiate sequence of horizontal swipes through the contact list with a swipe in either direction: For example, if a user is talking to a contact named “Danny” but wants to start talking with a different contact named “Kim” in the user's PCOM contact list, then the user can swipe left OR swipe right to hear the name of the Current PCOM Contact again—i.e. “Danny”, the most recently used contact—and then swipe that same direction again to hear the name of the second most recently used contact, then swipe that same direction again to hear the name of the third most recently used contact, and so on. At any point in that swipe sequence after the first swipe, the user can swipe the other direction to move back the other direction through the list of contact names.

In preferred embodiments, that first swipe in the sequence of swipes determines the direction to swipe through the list for this swipe sequence. And in preferred embodiments, as soon as the user does anything that can be interpreted as ending this swipe sequence (such as pushing-to-talk to someone, or double-tapping to re-hear the name of the Current PCOM Contact as discussed below, or tapping once after having swiped to a different contact name), then the current swipe sequence is considered over. The user can then start a new swipe sequence through the list of contacts with a swipe in either direction (starting again at the front of the list—i.e. at the Current PCOM Contact).

This ability to start horizontal swipe sequences in either direction (rather than having to remember that a specific direction always goes one way through the list while the other direction goes the other way) can be very helpful with PCOM devices that can be used in varying positions and orientations (e.g. worn on a collar or shirt pocket where the user can't easily see the PCOM device or any markings on it, with a speaker-opening on one PCOM device edge facing up toward the user's head, or sat on a table while that speaker opening facing toward the user's head): Such varying use positions, and the inability to easily see the device when worn on a collar, can make it difficult for many users to remember which horizontal direction to start swiping through the list, if the user were required to start swiping in a specific horizontal direction.

With the preferred approach described earlier, the user can start swiping substantially horizontally through the list in either direction. That means the user does not need to remember a specific direction to start swiping through the list.

FIG. 1 diagrammed navigating through a list of human contacts, showing how the list is maintained in most-recently-used order in preferred embodiments.

But in preferred PCOM system embodiments, a user's contact list can also include virtual agents, speech services, and PCOM plug-ins that allow a PCOM user to communicate with outside services. (PCOM plug-ins are discussed in more detail in other parts of this disclosure, in conjunction with FIG. 3.) And in preferred embodiments, users can use substantially the same gesture set and spoken-command set described above (or just slightly adjusted or expanded) to navigate through and interact “eyes free” with the agents and services represented on this expanded set of contact types.

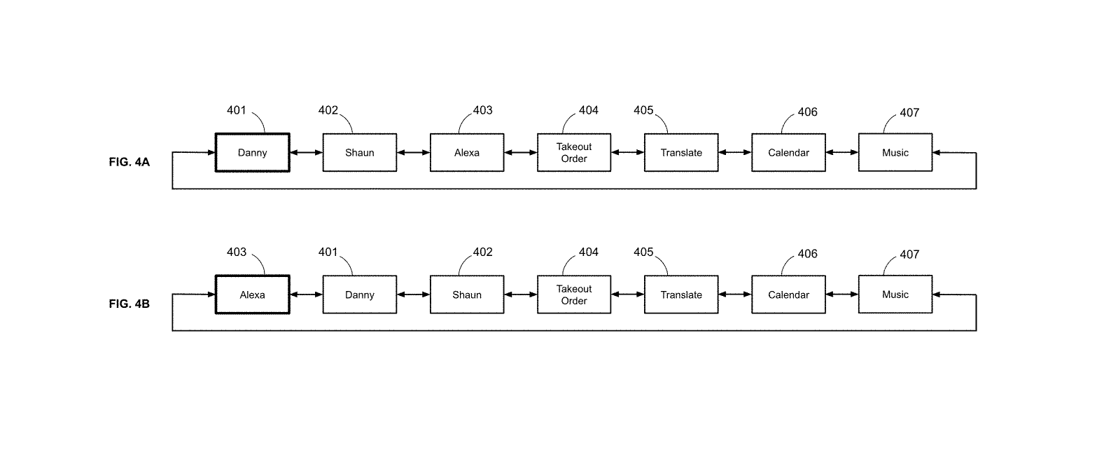

By way of example, FIG. 4A illustrates a PCOm contact list that includes the names of a couple human contacts (“Danny” 401 and “Shaun” 402), a couple virtual agents (“Alexa” 403 and “Takeout Order” 404), a speech service (“Translate” 405) that might be embodied in software on the same servers as the PCOM system, and the name of a couple external services (“Calendar” 406 and “Music” 407) that connect to the PCOM system through PCOM plug-ins.

In this example, a user could make the Alexa agent their “Current PCOM Contact” the same ways a human contact was made the Current PCOM Contact in the earlier examples—either by swiping horizontally repeatedly until hearing “Alexa” and then pressing-and-holding (or simply tapping once), or by using the spoken command gesture (e.g. tap+press-and-hold) and saying the desired contact name (“Alexa” in this example). Alexa would then be moved to the front of the list as shown in FIG. 4B (since Alexa is now the user's most-recently used contact—i.e. the new Current PCOM Contact)—so the user could simply press-and-hold to speak new commands or questions to Alexa, without having to say “Alexa” each time.

Not every contact must be moved to the front of the user's contact list each time it is used: PCOM System embodiments may allow configuration of which agents and under which circumstances are moved to the front. For example, and exception might be made when a user has an alternative shortcut for accessing a favorite or primary platform agent like Siri and uses that platform agent often: The user might not want to have to swipe past Ski to get to his other contacts after every use of Ski. But in general, we have found it useful to maintain the contact list in most recent order and to make the most recently used contact the Current PCOM Contact (moving it to the front of the list), since that tends to minimize the effort required to re-contact and interact with the most frequently used contacts (whether human or virtual).

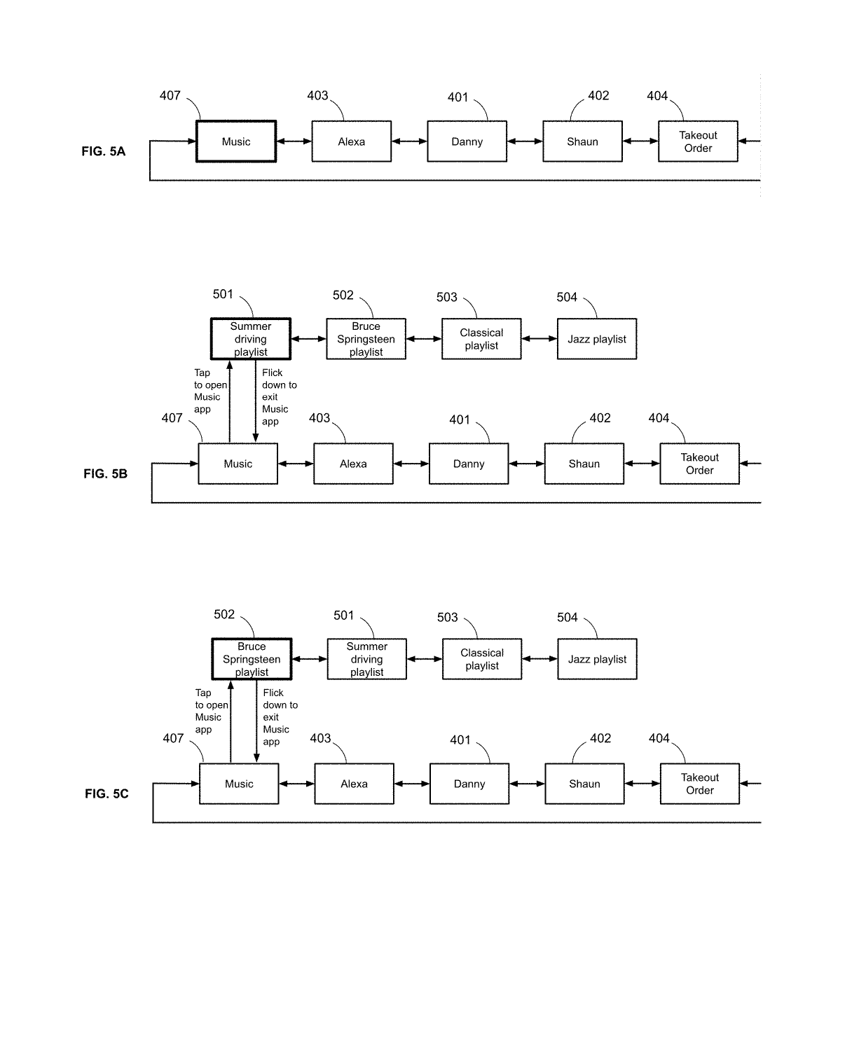

FIGS. 5A, 5B, and 5C illustrate an example of a preferred PCOM system embodiment that uses a slightly adjusted gesture interaction set to interact “eyes free” with a wider range of non-human contacts (including apps and services). FIG. 5A illustrates an example where a user has made the “Music” app their Current PCOM Contact in the same way as described earlier—by swiping to it and tapping (or pressing-and-holding) or by using a spoken command gesture and utterance (e.g. tap+press-and-hold and saying “Music”). This can also be referred to as “opening” or “launching” the Music app using PCOM. In this class of embodiments, when an agent or app is made the Current PCOM Contact (i.e. when the app is opened), the user can then continue interacting with it with horizontal swipe gestures—such as horizontally swiping through playlist names as illustrated in FIG. 5B—first hearing the most recently used Playlist name after the first swipe (which in FIG. 5B would be the “Summer Driving Playlist” 501), then hearing the second-most-recently used Playlist name (e.g. “Bruce Springsteen Playlist” 502) after the second swipe, and so on—similar to swiping through the contact names in the embodiments discussed earlier. In this preferred embodiment, the user can then tap after hearing the name of playlist they'd like to listen to, to make that the Current Playlist and start playing that playlist. For example, FIG. 5C illustrates the state after a user has opened the music app, and swiped through his playlists and tapped the “Bruce Springsteen Playlist” 502 to start playing it—moving the “Bruce Springsteen” playlist to the front of the list. (Notice that in FIG. 5C, the “Summer Driving Playlist” 501 is now the second most recently used playlist.) With this preferred embodiment, when the user is done listening to the music (i.e. done using the currently open app), the user can use a designated “back” gesture (such as flicking down) to stop the music and leave the music app (a.k.a. “exit” or “quit” the app or service): This returns the user to the state where horizontal swipes will navigate through the user's PCOM contact list again—as illustrated in FIG. 5A.

The addition of a designated back gesture for this context where a user has opened an app (whether the back gesture is a unique gesture or a repurposing of the flick-down mute gesture for this context) can allow a user to navigate to multiple levels of a PCOM-enabled app or service. For example, within a music app, alternative embodiments can allow swiping through the user's contact list until hearing “Music”; tapping to make the Music app the Current PCOM Contact (as in FIG. 5)—which we can also refer to as making the Music app “active” or “opening” the music app; swiping horizontally to hear names of playlists; tapping to open a given playlist whose name was just spoken; swiping horizontally repeatedly to hear the names of each song names within that playlist; tapping to play a song whose name was just spoken—then doing a back gesture (like flick down) to get back to the level in the app hierarchy where the user can swipe through the playlist names; then doing the back gesture again to exit the Music app. Of course, the user is generally navigating “eyes free” with PCOM, so it is helpful to keep navigation simple by minimizing the number of hierarchy levels through which a user would normally navigate when accessing an app from PCOM.

As with the earlier embodiments discussed, a double-tap could repeat the name of the current option (e.g. the name of a song if a song is playing, or the name of the currently selected playlist if the user has just tapped to open a given playlist but hasn't started playing music). In alternative embodiments, a double-tap could be used to open items within an app. For example, in the music app example above, in some embodiments a user could use the double-tap gesture to open a playlist. In still other examples, other gestures could be used to open items within in an app, such as a circle gesture.

Other alternative embodiments could use slightly different gestures for some of the other functions, such as using a double-tap instead of a flick down to navigate back to the prior level in the app hierarchy. The important element, if gesture navigation through apps is desired, is to designate a “back” gesture that can be used unambiguously while an app is open, so the user can exit the app.

Alternative embodiments can also let a user use general spoken commands to exit apps—speaking an utterances such as “Close Music”, “End Music”, “Exit”, “Quit”, or “Cancel”.

Preferred embodiments also allow users to speak app-specific commands to an app, service, or agent: For example, a user could swipe through his contact names until hearing “Music” (as described earlier), then press-and-hold and say “Play my Bruce Springsteen songs” or “Shuffle Summer Driving playlist”. The PCOM agent or service that is being spoken too, possibly created by a third party, could determine the set of utterances (or full language model) can be handled by that agent.

Related Notes about PCOM Systems, Devices, and Gestures:

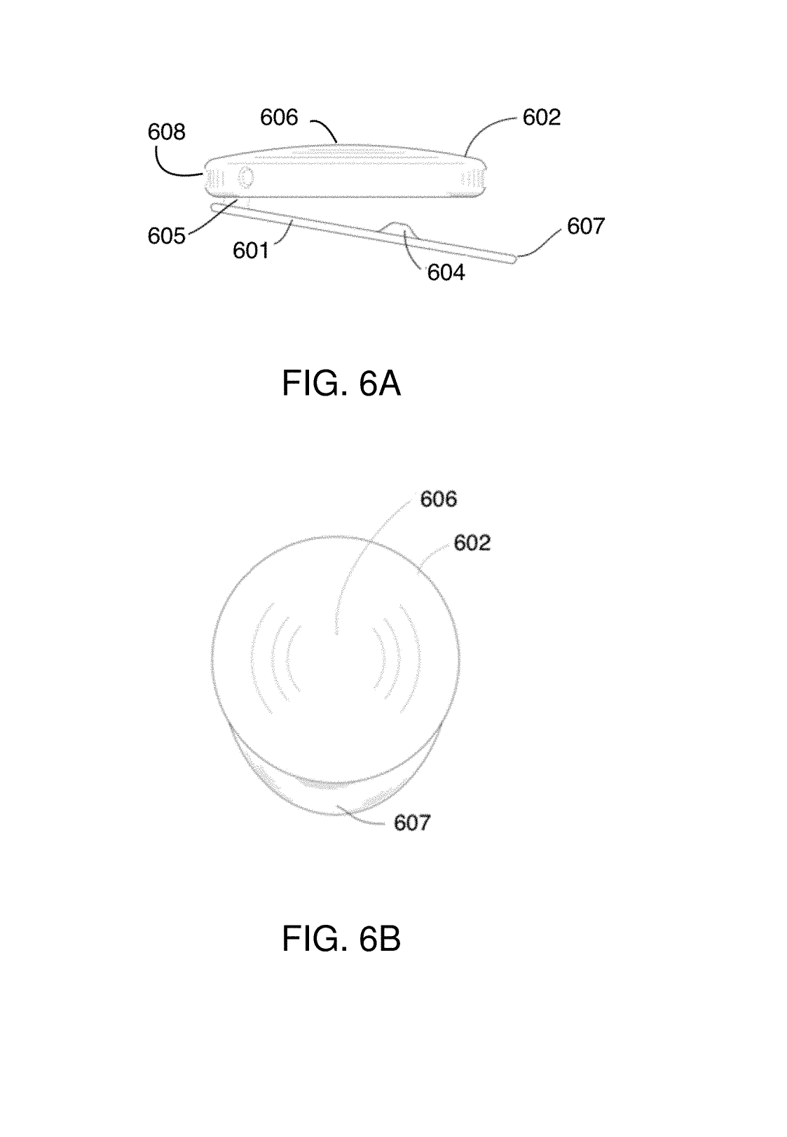

Note that with preferred PCOM device designs (like the one whose left side is illustrated in FIG. 6A and whose top view is illustrated in FIG. 6B—illustrations that were also in an earlier disclosure), physical features on the device 602 such as a longer “tail” 607 (on the clip plate 601) that extends further beyond the back of the device than the front of the device, to help the user aim a speaker opening 608 that is on the front edge toward the user's head when they clip on the device or sit on the table. So when wearing a PCOM device on a collar, or using the device on a table, it is easy to remember and sense “up” and “down”—i.e. for vertical swipes and slides: Up is toward your head, down is away from your head. For example, preferred PCOM embodiments let users adjust volume or mute/un-mute with vertical slides and swipes. As seen in FIG. 6B, the user could raise the volume by sliding a finger “vertically” along the slightly rounded top 606 of the device, sliding from the back of the device toward the front of the device (e.g. sliding up in FIG. 6B, along the top 606 of the device). Again, the long tail 607 of the clip plate 601 extends further on the back of the device, letting the user know which end is the back of the device. That also makes it easy to know how to swipe the device “horizontally”: Just swipe substantially perpendicular to a vertical swipe—i.e. swipe substantially horizontally across the middle of the top 606 of the device illustrated in FIG. 6B. (FIG. 6A also shows other features that are part of preferred embodiments in PCOM devices discussed in earlier disclosures, including a fixed post or hinge 605 and one of the free posts 604 on the hinge plate that would normally rest against the bottom of the main body of the device 602 to keep the device stable when the device is sitting on a table.)

But as noted earlier, even though it is relatively easy to determine what represents a substantially “horizontal” swipe direction, it can be more difficult to remember to swipe in a specific horizontal direction (left, not right; or right, not left). The preferred approaches described above where the contact list is maintained in most recently used order make it so a user does not need to remember a specific horizontal direction (the hard part): They just need to know how to swipe substantially horizontally in either direction.

### Calibration Option:

As noted earlier, the physical PCOM device design should make it relatively easy for a user to instantly know how to swipe substantially horizontally (or substantially vertically), as soon as they clip on the PCOM device and aim the speaker opening toward their head. But preferred embodiments of the PCOM app can also provide a simple set up sequence to help the user confirm a horizontal swipe. For example, when the device is clipped on, and the user taps it the first time (or does some other designated gesture any time), the PCOM app can use the PCOM device to prompt the user to “swipe horizontally” (or “swipe back and forth horizontally” or something related to that), then detect as the user does that gesture, and use the resulting touch event data to calibrate the device for what the user assumes is the horizontal direction: For example, anything within some angle (such as 45 degrees) of that swipe can be considered “substantially horizontal”, and anything else can be considered “substantially vertical”.

Earlier it was noted that in preferred embodiments, when the user starts a new substantially horizontal swipe sequence, the app (preferably through the PCOM device) first states the name of the Current PCOM Contact; then on the next swipe in the same direction, it can state the name of the second-most-recently used contact in the user's PCOM contact list, and so on.

In alternative embodiments, when the user does the first swipe of a new swipe sequence, the app can jump to saying the name of the second-most-recently-used contact—rather than saying the name of the Current PCOM Contact on the first swipe. That said, the inventor found that users tend to find it a little easier to understand and picture their place in the list if the first swipe states the name of the Current PCOM Contact (i.e. the most recently used contact)—even if that seems a bit redundant if the user had just been talking to that user)—and then the second swipe states the name of the second-most-recently-used contact, and so on.

The inventor also found that if the user has swiped through the contact list to a given name, but did not push-to-talk (or tap) to make the contact with that name the new Current PCOM Contact, and then did not interact with PCOM for some period of time (even as short as 10 or 15 seconds), then the user could easily forget they had started a swipe sequence (especially if they got distracted by some other task). So for this case where the user didn't interact with the PCOM for some time after starting a swipe sequence, it was found to be helpful to reset the swipe sequence: If the user then started swiping again, it would restart form the front of the list (i.e. from the Current PCOM Contact).

We found it can be useful to treat this list of contacts as circular when reaching the end of the list: When the user reaches the end of the list, and swipes again in the same direction, loop back to the front of the list.

When a user starts swiping one or more times in a first direction, and then switches to the substantially opposite second direction during the same swipe sequence and swipes one or more times to get back to the front of the list, if they then swipe again in that second direction past the front of the list, the PCOM app can either go to the second most-recently used contact (i.e. state that second-most-recently-used contacts name), and then on the next swipe in that second direction it can go to the third most-recently used contact, and so on—as if the user has started a new swipe sequence from the front of the list by swiping in the other second direction; or when the user swipes in that second direction back past the front of the list, the PCOM app can jump around to the end of the list (treating it as circular).

Other advantages to maintaining a user's PCOM Contact List in most-recently-used order reveal themselves when one starts to use embodiments employing the approach. For example, if you are “intercoming” with one person named Danny and then another person named Joe interrupts with a PCOM intercom message to you (thereby becoming your new “Current PCOM Contact”), you can reply to Joe by simply pressing-talking, then swipe once (in either direction!) to get back to talking with Danny.

In general, tis approach of maintaining a user's PCOM Contact List in “most recently used order” helps minimize the effort to talk with frequently used contacts on PCOM devices that don't provide significant visual feedback to user interactions.

### Responding to Incoming Phone Call

As noted, in preferred PCOM embodiments, users can answer incoming phone calls with PCOM by performing a gesture, such as simply tapping once on the PCOM sensor when the incoming call is occurring.

In preferred embodiments, when a phone call comes in, but it has not been answered yet and has not been sent to voice message recording yet—so the call is “pending”—the PCOM can (depending on user settings in the app and the current mute setting) make the PCOM LED flash and/or make the PCOM vibration component pulse and/or play a sound through the PCOM. Some embodiments can provide a means to allow the user to adjust the LED and Vibe patterns based on who the caller is (e.g. using a PCOM smartphone app for configuration).

When there is a pending incoming call (i.e. it is “pending” because it is incoming but it has not been answered yet and it has not been sent to voice message recording yet), or a call in progress, preferred PCOM embodiments can support related gestures such as:
Tap: Answer the pending incoming call.
Double Tap either during the call or when there is a pending incoming call, to have PCOM speak the name of caller. This matches the standard PCOm double-tap behavior, used to identify current PCOM contact when using PCOM as an intercom.
Slide up or down to adjust volume (same as regular PCOM use).
Flick down to immediately send a pending incoming call to voice mail—stopping and sounds, vibes, or LED activity related to the incoming call. Or if a call is already in progress, flick-down can end the call. (If the call is already in progress, a tap could be used to hangup—but a flick-down may be less error prone.)

During the call, a PCOM embodiment could either just let users talk as if PCOM is a speaker phone or headset, or it could make the user press the touch sensor when talking (as a user does when using PCOM as an intercom). Or a PCOM embodiment could enable either option, and let a user configure it according to their preference.

PCOM systems and devices designed according to the present invention make it easy to rapidly switch among and talk live with multiple human contacts, virtual agents, speech services. Some interesting use cases enabled by this approach include:
You can be talking live with one person (intercom-style or on a phone call) and then use a talk-with-agent gesture (e.g. tap+press-and-hold) to ask an agent a question relevant to your conversation, without ending the conversation with a person. For example, as you are discussing a trip with someone, you might want to quickly ask an agent what the weather will be tomorrow. Or you might want your wife to hear the agent's response—a feature which could be done by default with the talk-with-agent gesture (e.g. tap+press-and-hold) or could be made available through another gesture (such as double-tap+press-and-hold—like a triple-tap except the finger stays down after the third touch).
You can access specialized speech services or agents for specific contexts. For example, while traveling you might want to swipe to a “Translate” speech service, as described earlier (or use a spoken command like “Translate”), so you can then just press-and-hold and speech phrases and hear that Translate speech service speak back the translated utterances.
You could “follow” other people or virtual agents, and then hear them when they speak (or broadcast) utterance via their PCOM accounts. For example, if you are a fan of Warren Buffet's investing advice, you could follow Mr. Buffet's PCOM announcements. Or if you want regular updates on your favorite sport team's progress, you could subscribe to or follow a sports-updated virtual agent and ask to be kept informed whenever your team starts a game, scores, or finishes a game. That virtual agent would speak the information to people following that team on their PCOM accounts.
If you are using a PCOM device while waking around town or driving somewhere, a virtual agent or speech service could keep you informed of events, offers, or interesting information related to nearby locations. (“The coffee shop on this street gets 5 star reviews.”, “Bruce Springsteen is playing here next month.”, etc.) This feature could be part of a location aware, speech-based advertising network embodied as a speech service or virtual agent that could serve speech-based ads to individual PCOM that are potentially chosen or customized for each user based some combination of context and attributes such as the user's current location, mode of transportation (walking vs driving?), time of day, user preferences, user profile information, and so on.

Variations of the PCOM devices can be designed without speakers or microphones—so the PCOM device and its touch sensor would act primarily as an input/control device for PCOM speech services, while the user uses a different mechanism (such as a Bluetooth® headset, or a car audio system) to hear and talk to the PCOM system.

And other variations—or other configurations of the PCOM system—could use the PCOM touch sensor and the PCOM device microphone for audio input, while using other speakers (such as car speakers) foe output. For example, many cars have microphones that are not well suited for reliable speech recognition (sometimes because they don't record at high enough audio quality, other times because they aren't directional are not well positioned relative to the person speaking). For those situations, it can be helpful to have a relatively high quality microphone and audio system on a device that the user can pin to a shirt or position nearby (like on the steering wheel) to use for audio input to PCOM services, even if the user prefers to use the car's speakers for audio output from PCOM services while driving.

Other variations of the PCOM devices and services could be configured so a PCOM device and its touch sensor (with or without speaker and microphones) act as a remote control for a conferencing system, intercom system, or phone system positioned somewhere else in the room or building—letting the user use PCOM to do some combination of PCOM-like features, some of which may be implemented by the remotely controlled system rather than by the PCOM system. For example, if a conference room phone system has a contact list and can place calls, a PCOM device could potentially be configured to let a user walk into the room, start swiping through the list of contact names, and initiate a call to a given user, just as described earlier—but using the conference room phone system instead of the user's smartphone.

Embodiments of the PCOM devices can also be used to control common functions of music apps running on a smartphone paired with the PCOM—or music systems remote from the PCOM. For example, in certain contexts when a music app is playing music, sliding up or down on the PCOM can adjust the volume of the music. A quick flick down or up—or another gesture such as a tap—could be used to pause or resume the music (or mute or un-mute it). A horizontal flick gesture in some contexts when music is playing could be used to switch to the next or previous song in a playlist or music library. Other gestures could be used to invoke other music-app-related functions.

As agents (especially ones that communicate through speech) become more sophisticated, users will expect them to show something like manners and etiquette—such as avoiding interrupting the user. With preferred embodiments of the PCOM device and system, when incoming audio (such as a spoken utterance from a virtual agent or another person) is about to be played to the user, the PCOM device and system can first use the PCOM microphones to listen to see if the user is currently talking (potentially to another person nearby) and defer or skip playing the incoming audio. For example, if a user has an agent that updates the user about is favorite baseball team's game, and that team just scored (so the agent is set to provide an audible update via the user's PCOM) but the PCOM device and system determine that the user is currently talking to someone else, then the system could be set up to wait for some reasonable pause in the conversation (such as 3 seconds) and then say something like, “Excuse me. Buster Posey just hit a 3 run home run. The score is now 5 to 3.”. (The user should be able to stop any such speech with a gesture—such as a swipe down, or a perhaps a tap while the agent is still talking.)

Preferred embodiments of the PCOM system can use heuristics (or enable speech-based agents to use heuristics) that factor in some combination of the user's context (e.g. location, walking vs. driving, time of day, does their calendar indicate they are likely on their way to a meeting, etc.) or environment (e.g. does the PCOM device, using its microphone, detect that the user is talking right now?) to determine whether it not it should immediately play incoming audio as usual (e.g. from another PCOM user or agent) or wait until later (e.g. vibrate and wait until the user taps the PCOM sensor) or take some other action (like just skip playing this audio).

The PCOM system is open-ended enough to allow the creation of a very wide range of speech-based agents and services. For example, if an agent can control your TV through commands like “Record tonight's Giants baseball game”, it could be integrated with PCOM to allow talking with that agent through a PCOM device: A user could simply swipe to that agent on PCOM (or speak that agent's name after pressing a designated talk-with-agent gesture such as tap+press-and-hold), then press-and-hold and speak that command.

Now a few more embodiments of PCOM devices (e.g. “PCOM-enabled” devices) and PCOM systems and methods will be described and illustrated.

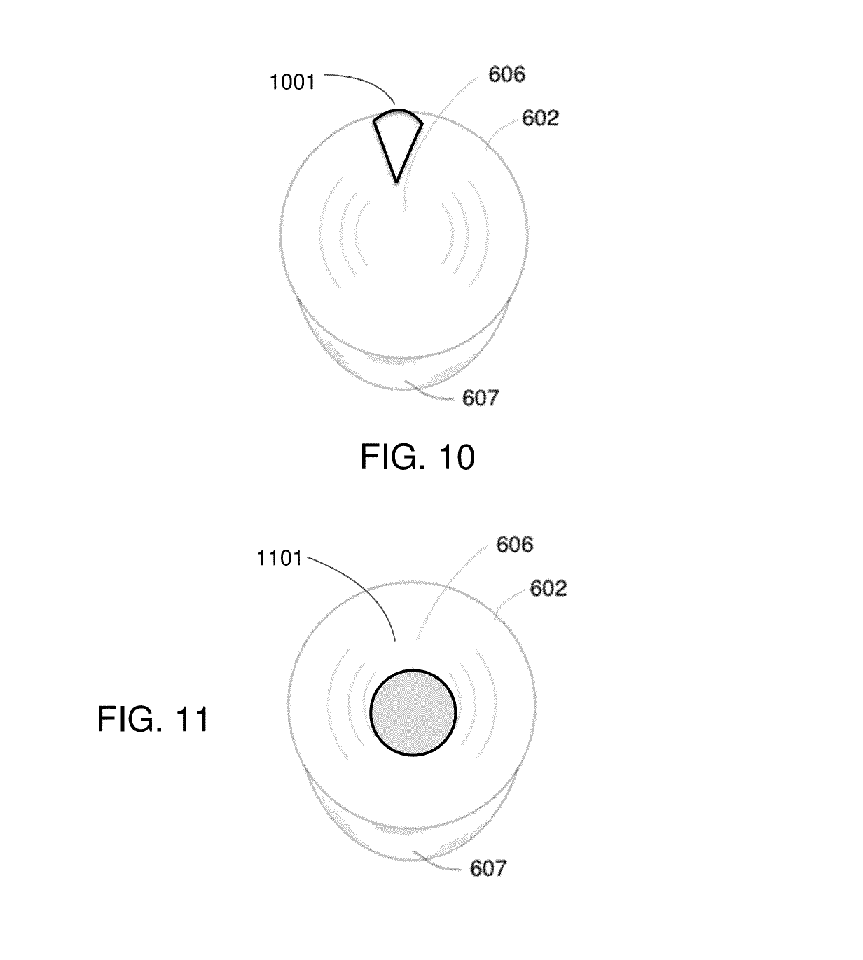

Variations of the PCOM devices (or “PCOM-enabled” devices) can include one or two cameras. Some embodiments could have a single camera that faces straight up out of the top surface of the PCOM device so that, when worn on a shirt, the camera faces in the direction that the wearer's chest is facing—so the camera tends to see what the wearer is seeing. Other embodiments, like the one illustrated in FIG. 10, could have a single camera 1001 that faces the same direction that a speaker port (608 in FIG. 6) faces out from the front edge of the device (e.g. in embodiments where the microphone ports are positioned on each side of the speaker port)—so that when the device is sitting on a table and being used as a mini conferencing device, the camera faces toward the person speaking into the device's microphones and listening the device's speaker: This would allow the device to record images of the device's user that can be transmitted to whomever that user is talking to. Still other embodiments could include two or more cameras, with one or more cameras facing the user who is speaking into the device when it is sitting flat on a table, and one or more other cameras facing in other directions.

Other embodiments of PCOM-enabled devices can include components for reading finger prints, like those round on some smartphones in 2016. For example, the embodiment illustrated in FIG. 11 includes a fingerprint reader component with a finger-print reading sensor 1101 positioned on the top surface of the device. With this embodiment, when a person presses a finger on that sensor (or swipes it across the sensor if it's a sensor that requires swiping to read the finger print), the finger-print reading component (driven by a processor on the device or on a connected device such as a smartphone) could read the user's fingerprint and use the resulting data to confirm the identity of the user at substantially the same time the user uses PCOM to speaks a request to the PCOM Agent or to another agent or bot to carry out an action only if the user's identity is confirmed as being authorized to invoke that action. For example, a user of this embodiment of PCOM who had set up a an agent or bot to facilitate opening or closing a garage door could press their finger on the PCOM's finger print sensor and say “Open my garage door” to open that garage door, if the user is authorized to do so. Or, as another example, if an agent were configured to allow turning on a furnace, a user could put their finger on the PCOM finger print sensor while saying “Turn on the heater” to turn it on, if the user is authorized to do so.

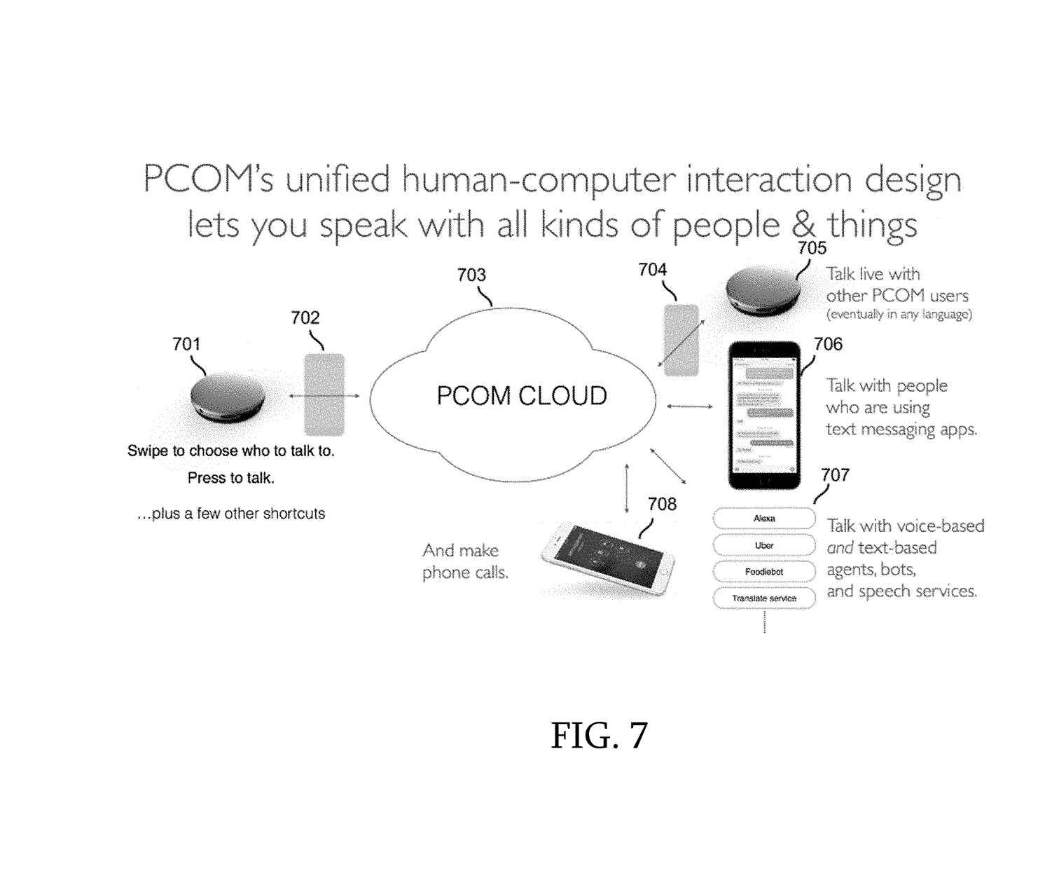

FIG. 7 illustrates the at a high level a PCOM System that uses a PCOM CLOUD sub-system to allow a user of a PCOM device 701 (also referred to as a PCOM-enabled device) to talk with a range of people and things using a single consistent user experience, including but not necessarily limited to users of other PCOM-enabled devices (705); people using text-based messaging apps 706 such as standard SMS, iMessage on iPhone, Facebook Messenger, and so on; people simply talking by voice on a phone 708; and a wide range of voice-based and text-based agents and bots 707, such as Alexa (a voice-based agent) and bots and services that accept text as input and respond with text as output. A good example of a text-based service is Google's translation service, which (after specification of an input and output language) allows input of a sentence in the input language and responds with the sentence translated to the output language. An example of a text-based bot would the ones that developers can create for Facebook messenger (or SMS) that let users “chat” with software cloud services by typing messages and reading the replies: There are text-based bots for ordering Pizza, getting information about airline flights, and many other tasks. (Some of these bots can also present graphical user interface elements when used on a device with a display.)

A key goal with PCOM is to allow PCOM users to easily talk with this wide range of people, agents, bots, and services, using a simple unified human interface. A few variations of this human interface are discussed in this document (including variations involving gestures to initiate listening by PCOM, variations that involve using speech to choose either gestures or speech or both to choose a new contact to talk to, and other variations that leave the microphone open).

Preferred PCOM embodiments allow users to differentiate between when they want to talk to the PCOM Agent 703 and when they want to talk to a Current Contact (which could be another PCOM user 705, a contact using a messaging app 706, or a bot or agent 707, for example). For example, one class of preferred embodiments lets a user talk to a current Current Contact simply by doing one simple gesture such as a press (a.k.a long-press or press-and-hold or press-to-talk) on a touch sensor or button on the PCOM (such as touch sensor 606 in the embodiment illustrated in FIG. 6A for example) while speaking to that contact—as with an intercom; and also lets the user talk to to the PCOM Agent by doing a different gesture such as a tap immediately followed by a sustained press (a.k.a. tap+press-to-talk or tap+long-press or tap+press) while speaking whatever they want the PCOM Agent to hear.

Different embodiments could use alternative gestures. And some embodiments could leave the microphone open (i.e. continue recording sound) as the user talks with the Current Contact and only require a gesture when the user wants to talk with the PCOM Agent. Other embodiments could potentially leave the microphone open as the user talks to the PCOM Agent and only require a gesture when talking with the Current Contact.

Another option is to leave the mic open and listen for a dedicated spoken phrase such as “PCOM” spoken at or near the start of any utterance that is to be interpreted by the PCOM agent or routed to a named user. But then the user needs to remember to structure utterances like “PCOM, tell Kim that Danny says he'll be here soon”—which imposes greater cognitive load on the user (and greater opportunity for error by the speech recognizer software) than simply doing a gesture (like tap+press) and saying “Kim, Danny says he'll be here soon.”

Still other embodiments could require one gesture (such as a press on a button or touch sensor on the PCOM's sensor like the sensor 606 in FIG. 6A) just as the user starts speaking to the current contact—and then allow the user to lift their fingers from the PCOM while continuing to speak or dialog with that contact. Similarly, embodiments could allow another gesture (distinct from any gesture used when speaking to or starting to speak to a Current Contact) just at the start of speaking with the PCOM Agent—and then allow the user to lift their fingers from the PCOM device while continuing to speak or dialog with the PCOM Agent, until the user is done speaking with the PCOM Agent. In some embodiments where the mic is left open when speaking to the PCOM Agent (or to a Current Contact), a user can indicate when they are done speaking to the PCOM Agent for now (or to the Current Contact) by doing a different gesture (such as swiping down on the PCOM surface's touch sensor 606 in the embodiment illustrated in FIG. 6B).

Still other embodiments could use a force sensitive touch sensor or multi-force-level single mechanical button to distinguish between talking to the PCOM agent and talking with the Current Contact. For example, a light press could be used when talking to a Current Contact, and a harder press could be required to talk to the PCOM agent.

Some preferred embodiments can allow a user to speak to the PCOM Agent by doing one gesture (such as pressing on a button or touch sensor on the PCOM) either for the duration of the utterance to the PCOM Agent or just at the start of the utterance; and then either deduce when the user is done speaking that utterance, or require or allow the user to use a different gesture (such as a swipe down) to indicate when they are done with that utterance; and then leave the microphone open while the user speaks to their current contact (until the user indicates they are done speaking to the current contact through some gesture or utterance or other action).

And in still other embodiments, a PCOM device could require a user to press one button or touch sensor to talk to (or start talking to) the PCOM Agent and press a different button or touch sensor to talk to (or start talking to) the Current Contact. One downside to this approach is that, if the PCOM device is fairly small (we found that users prefer it to be under 1.5 inches across) and is worn in a position where the user can not easily see it (such as on a shirt collar), the user could be prone to press the wrong button when reaching for it—sometimes accidentally speaking to a person when they meant to speak to the PCOM Agent. The inventor's initial user tests found that it can be easier to remember to make a unique gesture on a single device surface (such as tap+press for talking to the agent vs. a simple press to talk to a contact) than it is to accurately reach for and press a unique button on a small wearable device that can not easily be seen while being worn.

A key capability of preferred embodiments is that they let a user start talking with a new contact (i.e. make that contact the new Current Contact) by speaking an utterance to the PCOM Agent that addresses the new contact, typically by name. For example, in preferred embodiments, one or more of the following utterances (and potentially many more) could be used to switch to a new Current Contact:

“Danny, are you ready for the meeting?” to set the Current Contact to Danny and to send that first utterance (either “Danny, are you ready for the meeting?” or just “Are you ready for the meeting?”) to Danny.

“Alexa, what is the weather?” to set the Current Contact to an agent named Alexa and forward that utterance to it.

“Let me talk with Kim” to set the Current Contact to Kim, but not send any utterance to her yet.

And potentially natural language variations such as “Hey Uber, I need a ride” to set the Current Contact to an agent or bot named “Uber” and to send that utterance to it (either “Hey Uber, I need a ride” or “I need a ride”).

Embodiments could also have PCOM Agents that automatically set the Current Contact to an agent that knows how to address a given need expressed by the user. For example, if the user speaks “I'm hungry” to the PCOM agent, the PCOM Agent could change the Current Contact to a food ordering bot or agent, such as one named FoodieBot and the PCOM Agent or the Foodiebot agent or bot could say, “Foodiebot is here to help you”, and then the user could continue speaking with that new Current Contact as they would when speaking with a person via PCOM.

Note that in the case of utterances to the PCOM Agent such as “Danny, are you ready for the meeting?” or “Hey Kim, I'll be home soon” or “Uber, I need a ride.”, preferred embodiments of the PCOM system and PCOM Agent will use speech recognition and natural language understanding mechanisms (such as those provided by Google's api.ai service) to identify the contact being addressed (e.g. Danny or Kim, or an agent or bot named Uber) and automatically route the message to that contact being addressed. Preferred embodiments will also set the Current Contact to the contact being addressed—so the user can continue talking to that contact.

For example, in a preferred embodiment that requires a user to do a tap+press gesture on the PCOM device to let the user talk to the PCOM Agent while requiring a simple press to talk to a Current Contact, a user could talk to Danny and then Kim in quick succession by doing the tap+press gesture and saying “Danny, I'll get you that presentation tomorrow.” and then doing another tap+press gesture and saying “Kim, I'll be home in 10 minutes.” And after that second utterance in this example, the user could say something else to Kim (the new Current Contact) by just pressing on the PCOM device and speaking something else.

Once the Current Contact has been set to a new contact, the user can use the PCOM device and PCOM system to talk with that new Current Contact without having to make the gesture they'd be required to make to talk to (or start talking to) the PCOM Agent. For example, in preferred embodiments where a simple press is used when talking with the Current Contact (like an intercom) and a tap+press gesture is used when talking with the PCOM agent, a user can do a tap+press gesture and say “Kim, I'll be home soon” (which will make Kim the new Current Contact and send her that first utterance), and then if the user wants to say something else to Kim, they can just do a simple press and talk. Or in other embodiments where a press on a PCOM device touch sensor or button is required when talking to (or starting to talk to) the PCOM Agent and where the microphone is otherwise left open while a user talks with the Current Contact, a user can press and say “Talk with Kim” or “Kim, I'll be home soon” to the PCOM Agent (which the PCOM agent will respond to by making Kim the Current Contact and, in the latter case, forwarding that utterance to Kim), and then the user can continue talking with Kim without having to press the PCOM button or touch sensor.

Again, these preferred embodiments, the PCOM device and system let the user differentiates between speaking with the PCOM Agent and talking with the Current Contact—instead of having the user use just a single gesture (or an open mic) and always having to speak to the agent. That is important because in systems where a user must always must talk to the agent, it can become awkward to speak to a given contact. For example, Amazon's Echo product and Alexa agent platform supports “skills” (referred to as “domains” on some other agent platforms) that can allow sending messages to other users, but the user must ask Alexa to ask the skill to send the message. The resulting utterances are often awkward—sounding like the following with an Amazon skill named “SMS With Molly”, for example:

“Alexa, tell ‘SMS With Molly’ to send ‘Where are you?’ to Kim.”

“Alexa, tell ‘SMS With Molly’ to send ‘Can you get me a coffee?’ to Mr. Pallakoff.”

If Alexa directly supported messaging functions, these could no doubt be simplified to something like:

“Alexa, send the message ‘Where are you?’ to Kim.”

or “Alexa, say to Mr. Pallakoff ‘Can you please get me a coffee?’”

But even these simpler versions are fairly awkward and quite error prone: Alexa and the recognizer it uses can not hear those quotation marks and must successfully identify and interpret the names, including names that can be difficult to recognize.

By contrast, PCOM's approach significantly reduces the complexity for the system (reducing the opportunities for recognition errors) and also reduces the cognitive load for users. As discussed earlier, with preferred embodiments of PCOM the user can simply swipe to a given contact and then simply talk to that contact (e.g. while pressing a button or touch sensor “intercom-style”)—and that completely eliminates the need for the system to accurately recognize the contact's name. Or as discussed a few paragraphs up, in preferred embodiments of PCOM, a user can simply do a gesture such as tap+press to talk to the PCOM agent and say simple utterances like the following, which the PCOM agent will then automatically route to the person being addressed:

“Kim, where are you?”

or “Mr. Pallakoff, can you please get me a coffee?”

Speaking those to the PCOM agent still makes the system recognize the contact name (which can require some guidance from the user when the name is difficult to pronounce). But the overall utterance structure is simpler than the Amazon examples, and the name is at the start of the utterance, which simplifies the recognition task and makes it easier for a user to remember how to speak the utterance (compared to “Alexa, say to Mr. Pallakoff ‘Can you please get me a coffee?’” or “Alexa, tell ‘SMS With Molly’ to send ‘Can you get me a coffee?’ to Mr. Pallakoff.”).

Another advantage to using distinct gestures or modes when talking with the PCOM agent vs. when talking with the Current Contact is that it makes it avoids accidentally routing a message intended for the Current Contact to a different contact simply because the different contact's name is spoken at or near the front of the utterance. For example, if there were no distinct mode for talking to the PCOM agent vs. talking to the Current Contact and the system instead just listened for a person's name at the front of the utterance when routing a message, then if a user were talking to a contact named Kim and said “Danny can be here at noon” then the PCOM agent might route that message to Danny even if the speaker intended it to be sent to his Current Contact Kim. Preferred PCOM embodiments avoid that error by only routing a message to a name in the utterance if the user made the utterance (or started the utterance) while making the designated gesture (such as tap+press) that indicates the user is talking to the PCOM Agent (not the Current Contact).

All of these examples assume the user has had a chance to set up a list of their contacts (or favorite contacts) so they can swipe through that list on PCOM or speak the name of any given contact on the list via PCOM. This could be done by importing contacts from one of the user's existing contacts database (such as the contacts list on most user's smartphones, perhaps only important contacts marked as “favorites”). Or a supporting app or a web-based app could be used to let the user add contacts to their list of PCOM contacts. Or the user could potentially add PCOM contacts by speaking with the PCOM Agent—with utterances along the lines of “Please add a new contact”, with the PCOM agent responding “OK, what is this new contact's name?” and later “What is this contact's phone number?”, and so on.

In preferred embodiments, the PCOM system would also let the user associated other things with each PCOM contact—such as one or more unique nicknames or phonetic pronunciations (to help the speech recognizer recognize when the user says that name), and a specific vibration pattern or tune/tone to play when that contact sends a message to the user's PCOM when the user's PCOM is muted.

Preferred PCOM Agent and PCOM System embodiments include natural language processing elements (or use natural language services like Google's api.ai) to let users speak commands in a variety of ways. For example, a preferred embodiment would let s user ask the PCOM Agent to “Replay the last message received” by making that request in several different ways—such as “Replay”, “Replay message”, “Replay last message”, “Please play that message again”, and so on. (Those are just examples of possible variations.)

FIG. 8 illustrates an embodiment of the PCOM system in more detail—and in particular, it shows most of the cloud-based services that make up the PCOM Cloud 803 for this preferred embodiment. (Other embodiment can also include components that handle things like placing VoIP phone calls.) PCOM Cloud systems include speech recognition capabilities, to convert the user's speech to text—so the PCOM Cloud can forward that text to text-based messaging services 806 like SMS on phones or FB Messenger, and to text-based bots and services (like the Translate service discussed earlier in conjunction with 807). PCOM systems can also include speech-to-text (a.k.a. speech synthesis or text-to-speech) capabilities either as part of the PCOM Cloud 803 or running on smartphones that are paired with PCOM-enabled devices (like the “Smartphone 1” shown in FIG. 8 that is paired with the PCOM DEVICE 1). This text-to-speech feature can convert text-based responses from text-based services back to speech audio, so a PCOM user can hear the responses. PCOM embodiments can include components and services that are not shown in FIG. 8, such as components that facilitate making phone calls from PCOM.

Note that for FIG. 8 (detailed system), it is showing some of the components (not all—e.g. missing parts for placing calls) and this is just one of many possible embodiments. In other embodiments, other components in PCOM Server can talk directly feed voice through to external voice-based agent (like Alexa or Siri).

FIG. 9 illustrates the at a high level a PCOM System that uses a PCOM CLOUD sub-system to allow a user of a PCOM device 701 (also referred to as a PCOM-enabled device) to talk with a range of people and things. It is like FIG. 7, except FIG. 9 also shows illustrates that there can be a wide range of PCOM-enabled devices, including but not limited devices 910 that have wide-area radios that allows them to communicate with cloud services 703 without having to pair with a nearby mobile phone; devices 701 with local area radios—e.g. Bluetooth® for communicating with cloud services 703 through a nearby phone 702, or wi-fi radios for communicating with the cloud through nearby hotspots; devices 913 that can be integrated within or worn on clothes 912; headsets 914; and software that runs on smartphones 911, laptops, or computers and that emulates a PCOM device, where the smartphone, laptop, or computer communicates with the cloud service. (For example, the inventor's software team has created PCOM emulators running on smartphones as a means to help test and demonstrate the PCOM device and PCOM Cloud service user experience and feature set.) In all of these cases, preferred embodiments of the PCOM devices (or emulated device) support sound input (e.g. through one or more microphones), sound output (e.g. through one or more speakers), and 2D touch sensing.

PCOM device embodiments can also include headset jacks or electronics to connect wireles sly to headsets. PCOM embodiments can also be made without the speaker. And embodiments can all the user to use some other means to listen to the PCOM output, such as a regular Bluetooth®- or wired-headset connected to either the PCOM device or to the device through which the PCOM device connects to the cloud services. PCOM embodiments can also be built without a microphone, thereby consisting primarily of a touch sensor for controlling the PCOM features while the user talks through another microphone (e.g. in the phone or in a headset that has a microphone) and listens through one or more other speakers (e.g. in the phone or in a headset or in another connected speaker device).

Preferred embodiments of the PCOM System combine the gesture-based and speech-based interaction mechanisms described in this document. For example, in a preferred embodiment a user could choose a new contact to talk to either by swiping substantially horizontally across the touch sensor repeatedly (hearing the name of each contact in the user's PCOM contact list) and tapping once when they hear the name of the one they want to talk to, OR by tapping+pressing and saying “Talk with <name>”, where <name> is the name of the contact they want to talk to. In some contexts, a user may prefer to swipe through the contact list (for example, if they have recently talked to the contact they want to talk to but it's not the Current Contact yet, so they know they can find that contact with just a swipe or two).

What is claimed is:

1. A system and method for exchanging voice messages with both digital agents and people incorporating a uniform means for selecting the person(s) and/or agent(s) with whom the user wants to exchange voice messages.

2. The system and method of claim 1 wherein said means for selecting the person(s) and/or agent(s) is comprised of swiping substantially one direction or substantially the other direction through a list of said person(s) and/or agent(s).

3. The system and method of claim 1 wherein said means for selecting the person(s) and/or agent(s) is comprised of speech recognition and interpretation subsystems that allow the user to speak an utterance consisting of the name(s) or ID(s) of person(s) and/or agent(s) and a message to be sent to said person(s) and/or agent(s) and that then sends said message to said chosen person(s) or agent(s).

4. The system and method of claim 3 that only listens for said utterance within a short period after a touch gesture on a device with a touch sensor, where said touch gesture can be a tap or a press-and-hold or another gesture.
